(19) United States
(12) Patent Application Publication
(10) Pub. No.: US 2015/0174542 A1
(43) Pub. Date: Jun. 25, 2015

(54) MULTI-INGREDIENT MIXING DEVICE

(71) Applicants: Seong-Jae Lee, Seoul (KR); Jeong-Min Lee, Seoul (KR)

(72) Inventors: Seong-Jae Lee, Seoul (KR); Jeong-Min Lee, Seoul (KR)

(21) Appl. No.: 14/412,870

(22) PCT Filed: Nov. 22, 2010
(86) PCT No.: PCT/KR2010/008246

§ 371 Date: Feb. 17, 2015

(30) Foreign Application Priority Data
Apr. 26, 2010 (KR) 10-2010-0038669

(51) Int. Cl. B01F 15/02; B65D 47/06

(52) U.S. Cl. CPC B01F 15/0225; B01F 15/026; B65D 47/06; B65D 2547/063

(57) ABSTRACT

The disclosed multi-ingredient mixing device comprises: a container main body containing a content; and an actuator, which couples a cover, having a cover mouth part and a discharge hole, to an upper container mouth part of the container main body, the actuator being capable of opening a heterogeneous material storage space in a process in which a heterogeneous material accommodating unit is coupled at an inner discharge hole of the cover mouth part so as to surround the cover mouth part.

### TECHNICAL FIELD

The present invention relates to The present invention relates to a technology in which. while a heterogeneous material accommodating unit having a heterogeneous material storage space is coupled to a container main body corresponding thereto, a storage space sealing part for sealing the heterogeneous material storage space is broken to drop a different kind of material in the storage space into the container to be mixed in the container.

Also, the above-described heterogeneous material accommodating unit may be provided in plurality in the container having a predetermined volume. When the accommodating unit is coupled to the container after a liquid is provided in the container, contents contained in the accommodating unit are dropped to and mixed in the container. The present invention relates to a technology for reducing environmental pollutions by reusing the container several times or more.

### BACKGROUND ART

In a heterogeneous material accommodating unit according to a related, art, the heterogeneous material accommodating unit is coupled to a container containing pure water, and a different kind of material in the heterogeneous material accommodating unit is dripped to and mixed in the container while the heterogeneous material accommodating unit is opened. However, the above technology according to the related art has a limitation in that the device is disposable,

Also, there is another technology (Drop Tops Company. USA) in which a cover coupled to a container is a push/pull-up type, and a cartridge type heterogeneous material accommodating unit is inserted in a portion of the cover, and then the cover rotates to open the cartridge type heterogeneous material accommodating unit. However, in this technology, a large-scaled cover is required, and also the cartridge containing the different material may not be generally used.

### DISCLOSURE OF THE INVENTION

### Technical Problem

The accommodating unit and the cover for accommodating the accommodating unit manufactured by Drop Tops Company according to the related art need high manufacturing costs, however, according to the present invention, the cover is a general cover, and an actuator is simply added, in the cover to solve the cost matter.

Also, the accommodating unit adapted in the cover having the actuator may use an accommodating unit that is conventionally used or may he slightly changed in design to achieve the objectives of the present invention.

A reusable container for mixing different kinds of materials according to the present invention includes a container body containing a liquid. A screw thread is formed on a container mouth part of the container body to accommodate a cover. The cover that is coupled with respect to the container mouth part includes a cover mouth part having a screw thread to accommodate a heterogeneous material accommodating unit. At least one actuator is provided in an inner discharge hole of the cover mouth part.

Also, the actuator may cut or push a sealing surface of a bottom portion of the heterogeneous material, accommodating unit upward to open a heterogeneous material storage space. Here, a separate cap is disposed on the cover mouth part in which the actuator is disposed to maintain the container main body in a sealed state.

Also, several heterogeneous material accommodating units may be stored in the container storage space in the container main body and be distributed. A consumer may take out the heterogeneous material accommodating unit in the container main body to put the content into the container main body. When the heterogeneous material accommodating unit is coupled to the cover mouth part, the heterogeneous material storage space may be opened while it is coupled, and at the same time, a different kind of material stored in the heterogeneous material storage space may be dropped into the container storage space to be mixed in the container.

Also, at least one or more screw threads 26 and 27 having different sizes may be formed on the cover 20 in an inward direction of the screw thread S of the container 1 that is initially distributed so that the container mouth part 11 may be applied to various containers.

Also, according to the present invention, the heterogeneous material storage spaces 101 and 101′ of the heterogeneous material accommodating unit 100 may be provided in plurality, and the actuators 23 and 23′ corresponding to the heterogeneous material storage spaces 101 and 101′ may be provided in plurality.

### ADVANTAGEOUS EFFECTS

For the use of the reusable container and the disposable heterogeneous material accommodating unit, the actuator, which is a core element for opening the heterogeneous material accommodating unit, may be disposed in the discharge hole in the cover to significantly reduce opportunity costs.

### BRIEF DESCRIPTION OF THE DRAWINGS

FIG. 1 is a cross-sectional view illustrating a state in which a cover is coupled to a container main body.

FIG. 2 is a cross-sectional view illustrating a state in which the cover is coupled to the container main body, and an openable cap is coupled with respect to the cover,

FIG. 3 is a cross-sectional view illustrating a state in which a heterogeneous material accommodating unit is coupled to a container,

FIG. 4 is a cross-sectional view illustrating a state in which another modified heterogeneous material accommodating unit is coupled to a modified container.

FIG. 5 is a cross-sectional view illustrating a state in which another modified heterogeneous material accommodating unit is coupled to a modified container,

FIG. 6 is a cross-sectional view illustrating a modified example of the cover of the present invention.

FIG. 7 is a cross-sectional view illustrating a state in which another modified cover is assembled with the modified container of the present invention.

FIGS. 8 and 9 are cross-sectional views illustrating a modified example of FIG. 6 of the present invention.

### MODE FOR CARRYING OUT THE INVENTION

In a reusable container 1, a cover 20 including a cover mouth part 21 and a discharge hole 22 is coupled to a container main body 10 containing a content and a container mouth part 11 disposed on an upper portion of the container main body 10. Also, an actuator 23 for opening a heterogeneous material storage space 101 of a heterogeneous material accommodating unit 100 is disposed in the discharge hole 22 in the cover mouth part 21.

Also, a cap 30 for opening and closing the discharge hole 22 of the cover 20 is disposed on the cover 20. The cap 30 has a structure in which a sealing part 31 blocks the discharge hole 22. An opposite side of a cap guide part 32 is connected, to a connection part 24.

Also, the actuator 23 cuts or pushes the heterogeneous material storage space 101 of the heterogeneous material accommodating unit 100 upward to open the heterogeneous material storage space 101. A plurality of heterogeneous material accommodating units 100 coupled to the cover mouth part 21 of the cover 20 may be stored in a container storage space 12 in the container main body 10.

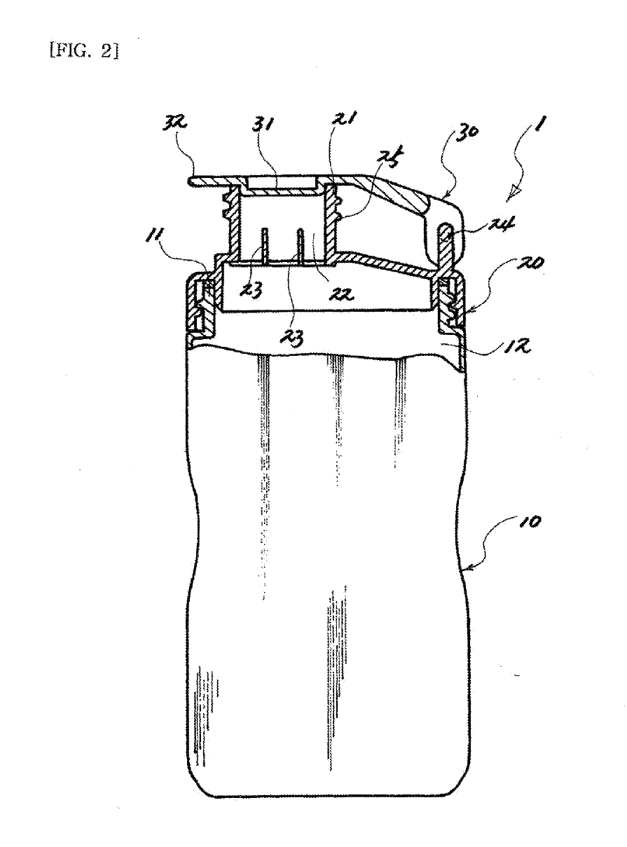

According to the present invention, the reusable container 1 that is currently distributed is illustrated in FIG. 2, the heterogeneous material accommodating unit 100 coupled with respect to a screw tread 25 of the cover mouth part 21 is disposed in the container storage space 12. Also, a general cover may be coupled to the cover mouth part 21. and thus the container may be distributed in a sealed, state or in a sealed state by using a shrink film.

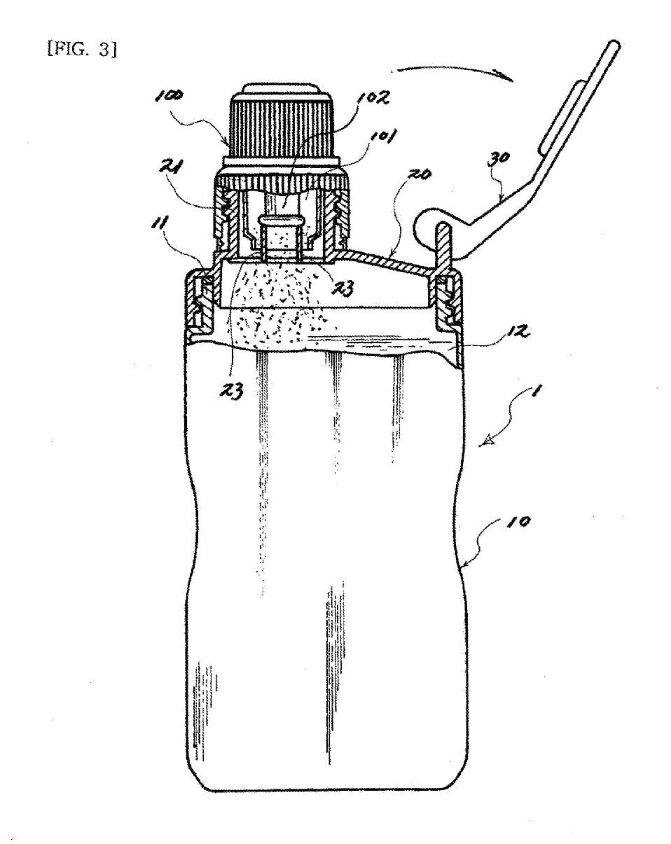

For the use of the heterogeneous material accommodating unit, the heterogeneous material accommodating unit 100 disposed in the container storage space 12 is taken out, and a content (e.g., a liquid, i.e., water) is supplied through the discharge hole 22. Then, when the heterogeneous material accommodating unit 100 is coupled with respect to the cover mouth part 21, the actuator 23 opens the heterogeneous material storage space 101, as illustrated in FIG. 3.

Preferably, as illustrated in FIG. 3, the actuator 23 pushes upward the storage space sealing part 102 of the heterogeneous material accommodating unit 100 to open the heterogeneous material storage space 101, and at the same time, a different kind of material (hereinafter, referred to as a “different material”) contained in the heterogeneous material storage space 101 is dropped and mixed in the container storage space.

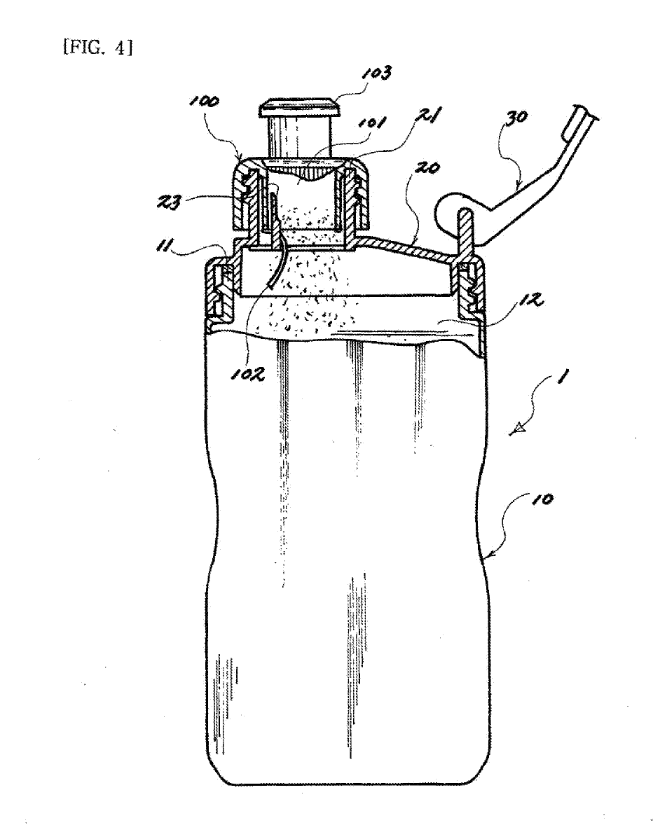

FIG. 4 illustrates a state in which a sharp actuator 23 cuts the storage space sealing part 102 of the heterogeneous material accommodating unit 100 to drop the different material contained in the heterogeneous material, storage space 101 into the container storage space 12 to be mixed in the container storage space 12. Also, an open/close part 103 is lifted to discharge the mixed content.

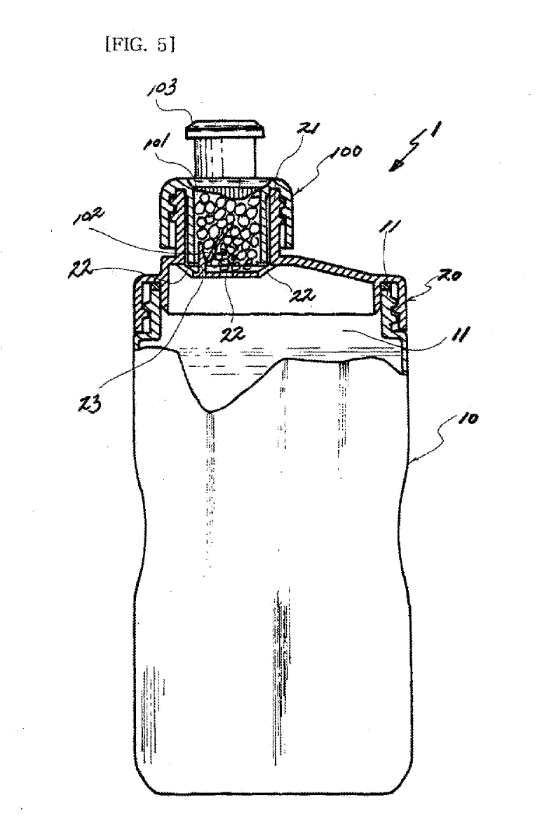

As another embodiment (see FIG. 5), a solid-state content having a flavor or smell may be put in the heterogeneous material storage space 101 of the heterogeneous material accommodating unit 100. When the heterogeneous material accommodating unit 100 is coupled with respect to the cover mouth, part 21 of the cover 20, the actuator 23 may break or punch a lower storage space sealing part for sealing the heterogeneous material storage space 101. Here, when the container main body 10 is slanted in one side, and the open/close part 103 is lifted, the content contained in the container storage space 12 may dissolve the solid-state content to discharge a content having a flavor or smell.

Also, the actuator 23 may have a predetermined space through which fluids vertically move. Alternatively, a plurality of discharge holes 22 may be defined on a position where the actuator 23 is disposed as illustrated in FIG. 5. In this case, it is preferable that the content contained in the heterogeneous material storage space 101 does not flow down into the container storage space 12.

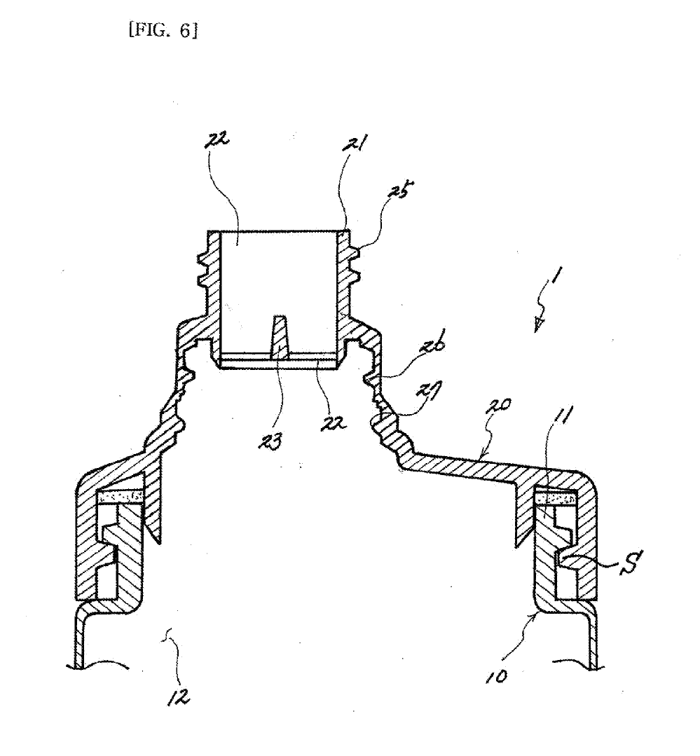

As further another embodiment (see FIG. 6), the present invention is characterized in that a plurality of screw threads S, 26, and 27, which are coupling parts, are provided so that the cover 20 is coupled to various containers having different sizes. FIG. 6 illustrates a state in which the cover 20 is coupled to a container neck having a large size. When it is intended to apply the cover 20 to a container neck having a small size, the screw threads 26 and 2 that are formed inward may be applied.

Alternatively, a hook protrusion may be provided instead of the screw threads S, 26, and 27, and the hook protrusion may be variously designed so that the hook protrusion is hooked by a hook protrusion of the container neck to maintain sealability.

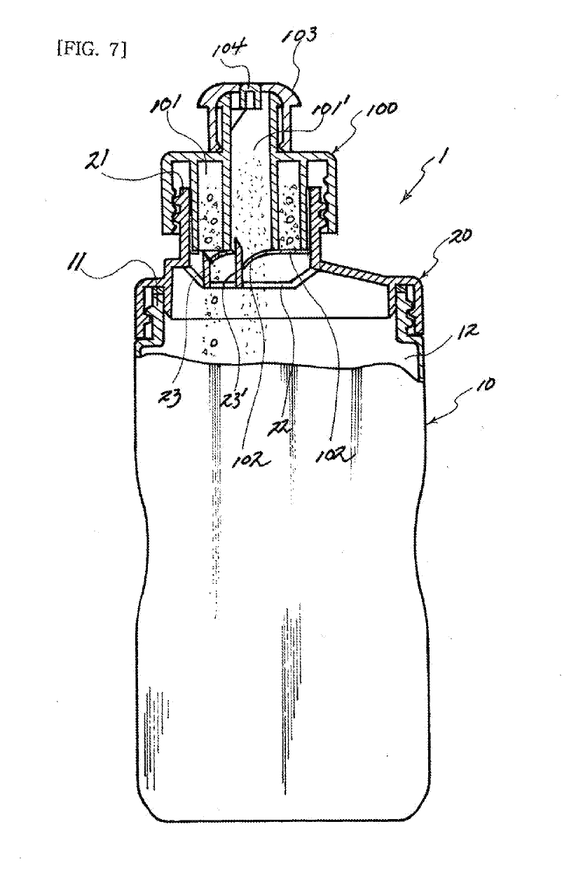

As further another embodiment (FIG. 7), according to the present invention, a plurality of actuators 23 and 23′ may be disposed inside the cover mouth part 21 of the container main, body 10. Also, a plurality of heterogeneous material storage spaces 101 and 101′ may be defined in the heterogeneous material accommodating unit 100 applied to the container main body 10.

For the use of the plurality of actuators, when the heterogeneous material accommodating unit 100 is coupled with respect to the cover mouth part 21, the storage space sealing part 102 for sealing a lower portion of each of the heterogeneous material storage spaces 101 and 101′ may be broken by the actuators 23 and 23′ corresponding thereto. At the same time, the contents in each of the heterogeneous material storage spaces 101 and 101′ may be dropped and mixed in the container storage space 12 as illustrated in FIG. 7.

Also, to discharge the contents, the open/close part 103 is lifted, and the container main body 10 is slanted in one side, then the contents may flow out of a sealing corresponding part 104 and thus be discharged through the open/close part 103

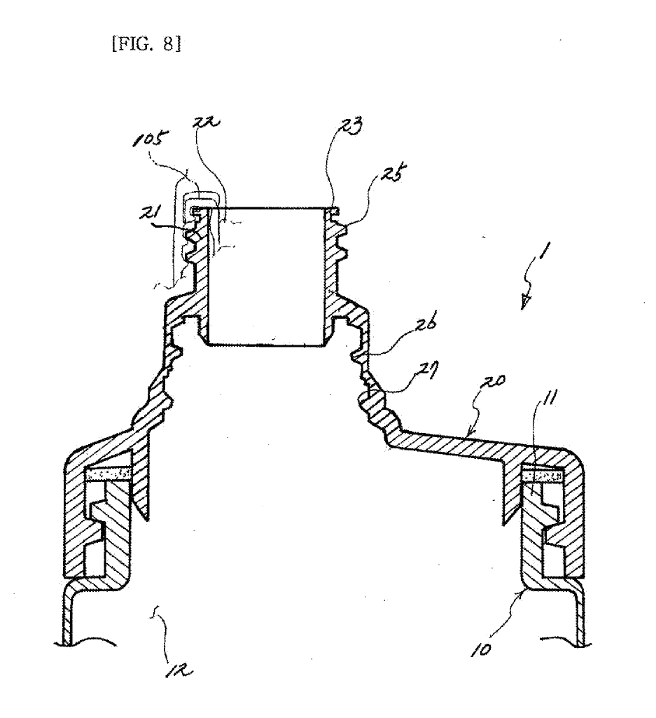

Also, further another embodiment (see FIG. 8) is described with refer FIG. 6, and thus the detailed description will be omitted. Here, an actuator 23 having a circular projection shape is disposed on an upper end of the cover mouth part 21.

Also, as illustrated in the figure with a dotted line, the actuator 23 may be used to open the heterogeneous material accommodating unit in a state where the coupling part 105 of the heterogeneous material accommodating unit is tightly fixed or to open the heterogeneous material accommodating unit by operating any one of coupling parts of the heterogeneous material accommodating unit during the coupling, thereby discharge the content contained in the storage space. That is, if any one part of the heterogeneous material accommodating unit does not rotate to be fixed to the cover mouth part 21, the actuator 23 may act as the part.

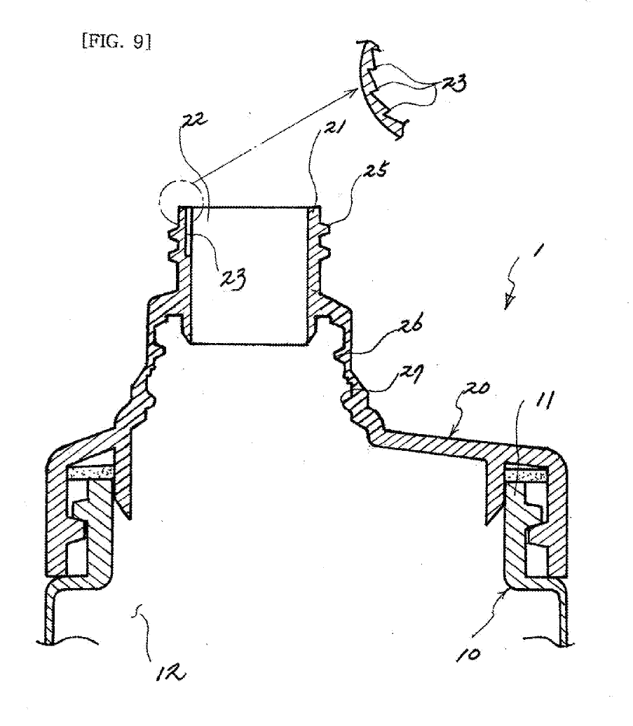

As further another embodiment (see FIG. 9), an example of the present invention is similar to that of FIG. 8. According to the features, an actuator 23 having a sawtooth shape is disposed on the inside the cover month, part 21.

For the use of the actuator 23 having a sawtooth shape, when the heterogeneous material accommodating unit is coupled to the cover mouth part 21, one part of the heterogeneous material accommodating unit is resisted by the actuator 23 having a sawtooth shape and thus does not rotate to stop. In this state, when the heterogeneous material accommodating unit is continuously coupled, a sealing part for blocking the storage space may be opened by a portion corresponding thereto. Such a technology may be understood by those skilled in the art, and thus a figure with respect to this is omitted.

Also, the sawtooth shape of the actuator 23 may be oppositely formed to open the storage space while the heterogeneous material accommodating unit is opened.

For reference (additional descriptions for FIGS. 8 and 9), the cover, which is a separation device, is coupled to the container main body containing the content and the container mouth part disposed on an upper portion of the container body. The screw thread, which is a coupling part, is formed on an upper end of the cover so that the heterogeneous material accommodating unit containing powder or a liquid therein is coupled thereto. Also, the actuator having a circular projection or sawtooth shape, which is a unit for breaking the sealing part, of the heterogeneous material accommodating unit, is disposed on the cover mouth part of the cover so that the different material contained in the heterogeneous material accommodating unit is dropped into the container while the heterogeneous material accommodating unit is coupled to the cover mouth part or opened after it is coupled.

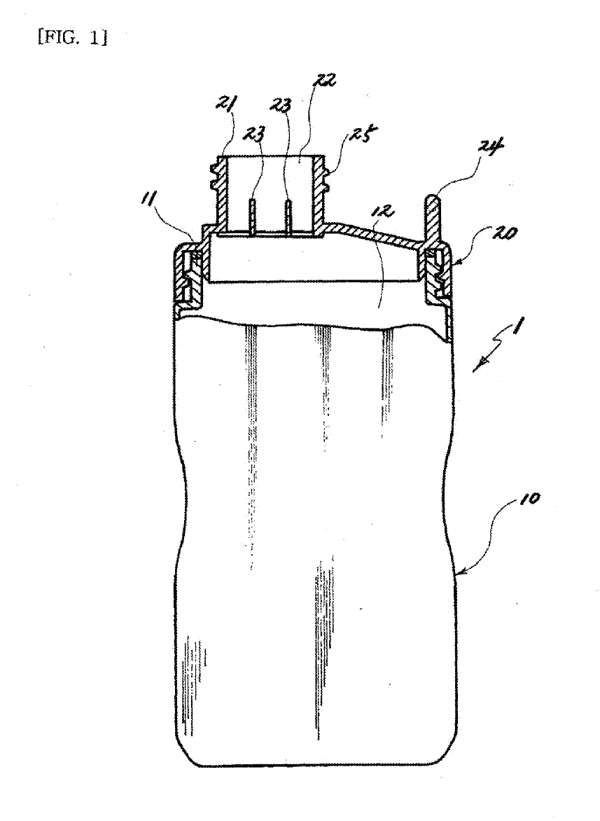

Also, the actuator 23 of FIG. 1 has to have a long length to easily lift or break the storage space sealing part of the heterogeneous material accommodating unit. Thus, the actuator 23 extends upward in a predetermined length. When an end of the actuator 23 contacts the storage space sealing part, the actuator 23 is pushed downward. Also, when the heterogeneous material accommodating unit is completely coupled with respect to the cover mouth part 21, as illustrated in FIG. 3, the actuator 23 is reduced, in resistance for pushing the storage space sealing part 102, Thus, the actuator 23 may further push the storage space sealing part 102 upward with, a small force.

Also, the connection, part nor supporting the actuator 23 may be provided in three connection parts that are disposed at an angle of about 120 degree to support the actuators 23. Alternatively, the actuators 23 may be disposed on four connection parts that are disposed at an angle of about 90 degree. Also, the connection part may be variously designed according to the heterogeneous material accommodating unit, and for example, the connection part may be disposed on a portion of the inside of the cover mouth part 21 or be spaced a predetermined distance apart from the lower portion of the cover mouth part 21, The connection may have an elastic part on a predetermined portion thereof unless the connection part acts as an elastic part in which the inside of the connection part is entirely maintained in an upward state at a predetermined angle.

### INDUSTRIAL APPLICABILITY

The container of the present invention may open the heterogeneous material accommodating unit having various shapes. Also, the container may be used in drinking water, beverages, alcohols, or medicine and medical supply or chemical fields, and particularly, widely applied in fields requiring long-term distribution without mixing with water.

1. A multi-ingredient mixing device, comprising a cover having a cover mouth part and a discharge hole is coupled to a container main body containing a content and a container mouth part disposed on an upper portion of the container main body, and an actuator is disposed in the discharge hole in the cover mouth part to open a heterogeneous material storage space while a heterogeneous material accommodating unit is coupled with respect to the cover mouth part.

2. The multi-ingredient mixing device of claim 1, wherein a cap for opening and closing the discharge hole of the cover is disposed on the cover.

3. The multi-ingredient mixing device of claim 1, wherein the actuator cuts or pushes the heterogeneous material storage space of the heterogeneous material accommodating unit upward to open the heterogeneous material storage space of the heterogeneous material accommodating unit.

4. The multi-ingredient mixing device of claim 1, wherein the heterogeneous material accommodating unit that is coupled to the cover mouth part of the cover is stored in a container storage space in the container main body.

5. A multi-ingredient mixing device wherein a container main body containing a content and a container mouth part disposed on an upper portion of the container main body have a size sufficient to allow a plurality of heterogeneous material accommodating units to be inserted into a container storage space, a cover having a cover mouth part and a discharge hole is coupled to the container mouth part disposed on the upper portion of the container main body, and the heterogeneous material accommodating unit is coupled with respect to the cover mouth part.

6. The multi-ingredient mixing device of claim 1, wherein the cover has a plurality of coupling parts that are capable of being coupled to container mouth parts having different sizes.

7. The multi-ingredient mixing device of claim 6, wherein each of the coupling parts has a screw thread shape.

8. The multi-ingredient mixing device of claim 5, wherein the cover has a plurality of coupling parts that are capable of being coupled to container mouth parts having different sizes.

9. The multi-ingredient mixing device of claim 1, wherein the actuator has a circular projection shape on an upper end of the cover mouth part.

10. The multi-ingredient mixing device of claim 1, wherein the actuator has a sawtooth shape on an inner wall of the cover mouth part.

11. The multi-ingredient mixing device of claim 1, wherein the actuator is provided in plurality, and
the heterogeneous material storage space of the heterogeneous material accommodating unit corresponding to the actuator is provided in plurality and has a storage space sealing part on a lower end thereof,
when the heterogeneous material accommodating unit is coupled with respect to the cover mouth part, the actuators break the storage space sealing part to drop different materials contained in the plurality of storage spaces into the container storage space to be mixed in the container storage space.

12. The multi-ingredient mixing device of claim 5, wherein the actuator is provided in plurality, and
the heterogeneous material storage space of the heterogeneous material accommodating unit corresponding to the actuator is provided in plurality and has a storage space sealing part on a lower end thereof,
when the heterogeneous material accommodating unit is coupled with respect to the cover mouth part, the actuators break the storage space sealing part to drop different materials contained in the plurality of storage spaces into the container storage space to be mixed in the container storage space.

13. The multi-ingredient mixing device of claim 5, wherein the actuator has a sawtooth shape on an inner wall of the cover mouth part.

14. A multi-ingredient mixing device, characterized in that comprising a cover, which is a separate connection device, is-coupled to a container main body containing a content and a container mouth part disposed on an upper portion of the container main body, and a screw thread, which is a coupling part, is-formed on an upper end of the cover so that a heterogeneous material accommodating unit containing powder or a liquid therein is coupled to the upper end of the cover,
wherein an actuator having a circular projection or sawtooth shape, which is a unit for breaking a sealing part of the heterogeneous material accommodating unit, is disposed on a cover mouth part of the cover so that a different kind of material contained in the heterogeneous material accommodating unit is dropped into the container while the heterogeneous material accommodating unit is coupled to the cover or is opened after it is coupled.

15. The multi-ingredient mixing device of claim 14, wherein the screw thread, which is a coupling parts, is provided in various sizes so that the cover is coupled to a plurality of container necks.
